(19) United States
(12) Patent Application Publication
(10) Pub. No.: US 2006/0040133 A1
(43) Pub. Date: Feb. 23, 2006

(54) Electrode structure of organic electroluminescent display panel and method of manufacturing the same

(76) Inventors: Wen-Jeng Lan, Chu-Nan (TW); Chin Chung Chang Chien, Chu-Nan (TW); Ming Te Lee, Chu-Nan (TW); Hui-Chang Yu, Chu-Nan (TW); Ting Chieh Chien, Chu-Nan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/179,547

(22) Filed: Jul. 13, 2005

(30) Foreign Application Priority Data
Jul. 13, 2004 (TW) 093120923

(51) Int. Cl. H01J 1/62; B32B 19/00

(52) U.S. Cl. 428/690; 313/504

(57) ABSTRACT

An electrode structure of an organic electroluminescent display panel and a method of manufacturing the same are provided. The electrode structure comprises a transparency substrate, a leading wire pattern layer (for example: ITO, IZO or IWO materials etc.) grown on the transparency substrate, at least one auxiliary metallic pattern layer grown on the leading wire pattern layer, an isolation area provided on the auxiliary metallic pattern layer for isolation, a separation area provided on the isolation area with an raised predetermined height to separate electric interference, and at least one metallic conductive layer provided on the transparency substrate and the separation area. By the separation area with the predetermined height separating apart and electrically isolating the metallic conductive layers respectively provided on the separation area and the auxiliary metallic pattern layer, the at least one metallic conductive layer on the separation area, the at least one metallic conductive layer on the auxiliary metallic pattern layer or the leading wire pattern layer, the auxiliary metallic pattern layer, and/or the leading wire pattern layer are in a series connection to reduce the electrode impedance.

### FIELD OF THE INVENTION

The present invention is related to an organic electroluminescent display panel and more particularly to an organic electroluminescent display panel with an external electrode leading wire with low impedance.

### BACKGROUND

Organic electroluminescence means a phenomenon using injection and compound of carriers to cause light emitting driven by an electric current. The principle is respectively using transparent electrodes made of ITO, IZO or IWO etc. materials and metallic electrodes as an anode and cathode of elements. Under a certain voltage driving, electrons and holes respectively inject to electronic and hole transport layers from the cathode and anode such that the electrons and the holes are moved to light emitting layer respectively through the electronic and hole transport layers and met in the light emitting layer to make light emitting molecules arouse visible light. The technical features of the organic electroluminescence comprises: self-light emitting, direct current low voltage driven (below 10V), high light emitting efficiency, low power, abundant light emitting colors, easy to achieve color display, simple techniques, low cost, outstanding temperature feature, light emitting function independent of temperatures, etc. Comparing with liquid crystal displays, the advantages of the organic electroluminescent displays are: (1) no visual angle problems; (2) thickness thereof thinner than that of the liquid crystal displays; (3) the cost of production in a large number thereof comparing favorably with that of the liquid crystal displays; (4) response time thereof better than that of the liquid crystal displays; (5) able to display in low temperatures, while the liquid crystal displays having slower response time in low temperatures. Even if the organic electroluminescence is a burgeoning technology currently, quite a bit difficulty are encountered in real applications, including: stability of maintaining light emitting in a very short time and difficulty of light emitting efficiency came from larger panels, waterproof packages came from the organic materials themselves and usage lifetime problems, non-uniformity of light emitting brightness and color caused by disproportion of the organic materials, etc.

Please refer to a first prior art organic electroluminescent display panel developed by Pioneer Electronic Corporation and disclosed in U.S. Pat. No. 5,399,936 which uses metallic leading wires to contact sides of transparent anode electrode surface, such as ITO and so on, to reduce the impedance of the anode electrode leading wires. Please refer to a second prior art organic electroluminescent display panel developed by NEC Ltd. and disclosed in JP Paten No. 10-106751 which uses such a metallic leading wire to contact both sides of transparent anode electrode surface, such as ITO and so on, to reduce the impedance of the anode electrode leading wires and does not need to injection carriers to prevent from decreasing light emitting efficiency. Please refer to a third prior art organic electroluminescent display panel developed by Pioneer Electronic Corporation and disclosed in U.S. Pat. No. 5,701,055 which uses a cathode isolation layer to separate cathode manufacture of pixel areas. Please refer to a fourth prior art organic electroluminescent display panel developed by Idemitsu Kosan and disclosed in JP Paten No. 3250583 which uses an isolation structure, such as insulator and so on, to define pixel light emitting areas.

It is known to all that the problem of ITO impedance of transparent electrodes affecting light emitting efficiency to reduce will be an important topic in a development process of the organic electroluminescent technology in the future. However, in the first prior art and second prior art of the above mentioned prior art technology, extra provided metallic leading wires are needed to achieve an object of reducing anode impedance and improving light emitting efficiency. The process cannot be simplified. On the contrary, a step of additionally providing the metallic leading wires is further needed. The third prior art and fourth prior art only disclose the structure improvement related to the organic electroluminescent display, it is a pioneer of simultaneously using existed steps in the process and giving consideration to other functions, but not helping to reduce the anode impedance.

Therefore, the inventor diligently studied and operated in coordination with theories to bring up the present invention with reasonable design and effectively improving the above mentioned shortcomings in respect to the above mentioned shortcomings.

### SUMMARY OF THE INVENTION

It is a primary object of the present invention to provide an electrode structure of an organic electroluminescent display panel and a method of manufacturing the same which uses an electrode isolation layer to make external leading wire area without additionally increasing material cost or increasing the process to effectively reduce impedance of external electrode leading wires. Reducing the impedance can improve entire functions, such as improving electric current amount if unit area, to improve the light emitting efficiency.

It is a secondary object of the present invention to provide an electrode structure of an organic electroluminescent display panel and a method of manufacturing the same which directly uses an electrode isolation layer to make external area leading wires, including both cathode and anode electrodes of external leading wires.

It is another object of the present invention to provide an electrode structure of an organic electroluminescent display panel and a method of manufacturing the same whose isolation structure, such as insulator and so on, defines the pixel light emitting area, as well as is the isolation structure of the external leading wires.

To achieve the above mentioned objects, the present invention provides an electrode structure of an organic electroluminescent display panel which comprises a transparency substrate, a leading wire pattern layer (for example: ITO, IZO or IWO etc.) grown on the transparency substrate, or at least one auxiliary metallic pattern layer grown on the leading wire pattern layer, an isolation area provided on the auxiliary metallic pattern layer as isolation, a separation area provided on the isolation area with an raised predetermined height to separate electric interference, and at least one metallic conductive layer provided on the transparency substrate and the separation area. By the separation area with the predetermined height separating apart and electrically isolating the metallic conductive layers respectively provided on the separation area and the auxiliary metallic pattern layer or the leading wire pattern layer, the at least one metallic conductive layer on the separation area, the at least one metallic conductive layer on the auxiliary metallic pattern layer, and the leading wire pattern layer are in a series connection to reduce the electrode impedance.

To achieve the previous mentioned objects, the present invention provides a process of manufacturing an organic electroluminescent display panel which comprises following steps: (a) making a transparency substrate; (b) using a photoresist material and a lithographic process to grow an isolation area on the transparency substrate as isolation; (c) applying the photoresist material on the obtained structure and then using the lithographic process to make a separation area with a predetermined height such that the separation area is existed on the isolation area; and (d) growing at least one metallic conductive layer on the obtained structure. This way, the at least one metallic conductive layer provided on the separation area and the metallic conductive layer or the leading wire pattern layer on the transparency substrate are separated apart and electrically isolated by the separation area with the predetermined height; and the metallic conductive layers on the separation area, the at least one metallic conductive layers on the transparency substrate, the auxiliary metallic pattern layer, and the leading wire pattern layer are in a series connection to reduce the electrode impedance.

For examiners to further understand the feature and technical content of the present invention, please refer following detailed description and accompanying drawings of the present invention. However, the accompanying drawings are only for reference and description, not for limiting the present invention.

### BRIEF DESCRIPTION OF DRAWINGS

FIG. 1 shows a top view diagram of an electrode structure of an organic electroluminescent display panel of the present invention;

FIG. 1A shows a partial magnified cross section view diagram of the electrode structure of the organic electroluminescent display panel of the present invention;

FIG. 2 shows a cross sectional diagram of a first embodiment of the electrode structure of the organic electroluminescent display panel of the present invention;

FIG. 3 shows a cross sectional diagram of a second embodiment of the electrode structure of the organic electroluminescent display panel of the present invention;

FIG. 4 shows a cross sectional diagram of a third embodiment of the electrode structure of the organic electroluminescent display panel of the present invention;

FIG. 5A to FIG. 5D show flow charts of the first embodiment of the electrode structure of the organic electroluminescent display panel of the present invention;

FIG. 6A to FIG. 6F show flow charts of the second embodiment of the electrode structure of the organic electroluminescent display panel of the present invention; and

FIG. 7A to FIG. 7H show flow charts of the third embodiment of the electrode structure of the organic electroluminescent display panel of the present invention.

### DETAILED DESCRIPTION

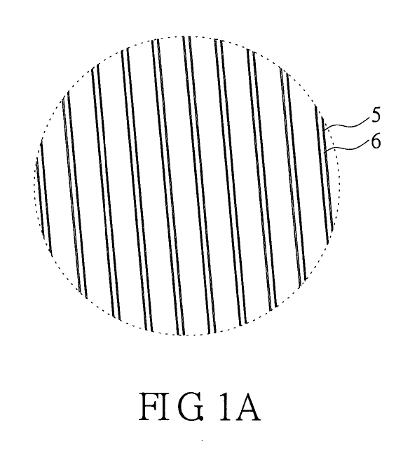

Please refer to FIG. 1 and FIG. 1A, an electrode structure of an organic electroluminescent display panel 10 provided by the present invention which comprises a cathode structure 11 and anode structure 12. As shown in FIG. 1A, the electrode leading wires are in parallel with each other and distinguish by an isolation area 5 and separation area 6 to avoid the electrode leading wires adjacent to each other from electrically connecting or electrically interfering. The conductive material of the electrode leading wires can comprise a leading wire pattern layer (for example: ITO, IZO or IWO etc.) and more than one metallic layer. The feature of a plurality of layers of such a conductive material in a series connection reducing total electrode impedance and reducing impedance as described in prior art are used to help improvement of the light emitting efficiency to achieve an object of improving the light emitting efficiency. In addition, such a structure does not need extra process or material cost, effectively reduces the impedance of the external electrode leading wires, and improves the light emitting efficiency.

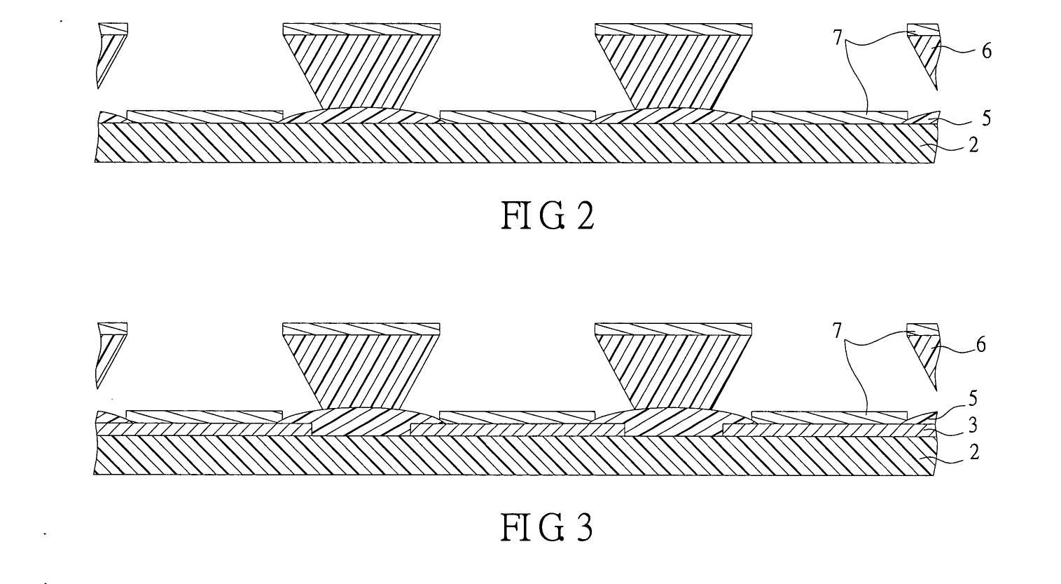

A first embodiment of the electrode structure of the organic electroluminescent display panel 10 of the present invention as shown in FIG. 2 comprises a transparency substrate 2, an isolation area 5 provided on the transparency substrate 2 as isolation, a separation area 6 provided on the isolation area 5 with a raised predetermined height to separate electrical interference, and at least one metallic conductive layer 7 provided on the transparency substrate 2 and the separation area 6. The isolation area 5 isolates the electrical connection of adjacent leading wires. The separation area 6 with the predetermined height separates from and electrically isolates the metallic conductive layers 7 respectively provided on the separation area 6 and the transparency substrate 2 and further avoids from electrical interference of adjacent leading wires. Besides, the at least one metallic conductive layer 7 on the separation area 6 and the at least one metallic conductive layer 7 on the transparency substrate 2 are in a series connection to reduce the electrode impedance.

A second embodiment of the electrode structure of the organic electroluminescent display panel 10 of the present invention as shown in FIG. 3 comprises a transparency substrate 2, a leading wire pattern layer 3 provided on the transparency substrate 2, an isolation area 5 provided on the leading wire pattern layer 3 as isolation, a separation area 6 provided on the isolation area 5 with a raised predetermined height to separate electrical interference, and at least one metallic conductive layer 7 provided on the leading wire pattern layer 3 and the separation area 6. The isolation area 5 isolates the electrical connection of adjacent leading wires. The separation area 6 with the predetermined height separates from and electrically isolates the metallic conductive layers 7 respectively provided on the separation area 6 and the leading wire pattern layer 3 and further avoids from electrical interference of adjacent leading wires. Besides, the at least one metallic conductive layer 7 on the separation area 6, the at least one metallic conductive layer 7 on the leading wire pattern layer 3, and the leading wire pattern layer 3 are in a series connection to reduce the electrode impedance.

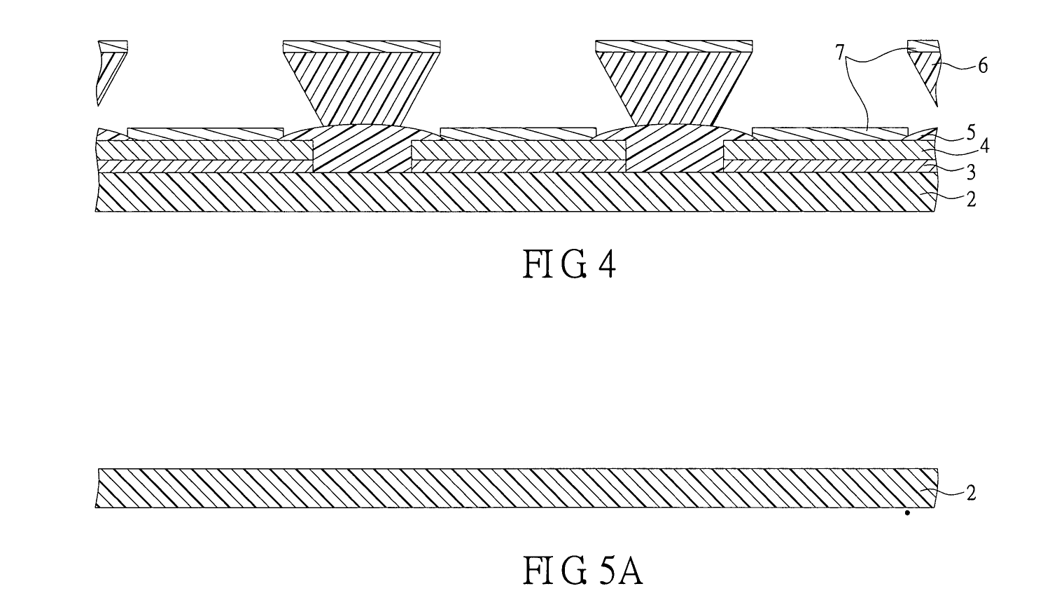

A third embodiment of the electrode structure of the organic electroluminescent display panel 10 of the present invention as shown in FIG. 4 comprises a transparency substrate 2, a leading wire pattern layer 3 provided on the transparency substrate 2, at least one auxiliary metallic conductive layer 4 provided on the leading wire pattern layer 3, an isolation area 5 provided on the leading wire pattern layer 3 as isolation, a separation area 6 provided on the isolation area 5 with a raised predetermined height to separate electrical interference, and at least one metallic conductive layer 7 provided on the auxiliary metallic conductive layer 4 and the separation area 6. The isolation area 5 isolates the electrical connection of adjacent leading wires. The separation area 6 with the predetermined height separates from and electrically isolates the at least one metallic conductive layer 7 provided on the separation area 6 and the at least one metallic conductive layer 7 provided on the auxiliary metallic conductive layer 4 and further avoids from electrical interference of adjacent leading wires. Besides, the metallic conductive layers 7 on the separation area 6 and the auxiliary metallic conductive layer 4, the leading wire pattern layer 3, and the auxiliary metallic conductive layer 4 are in a series connection to reduce the electrode impedance.

Among them, the leading wire pattern layer 3 in the above embodiment is made of an ITO, IZO or IWO material etc. The isolation area 5 and the separation area 6 can be made of a polyimide, acrylic or other materials.

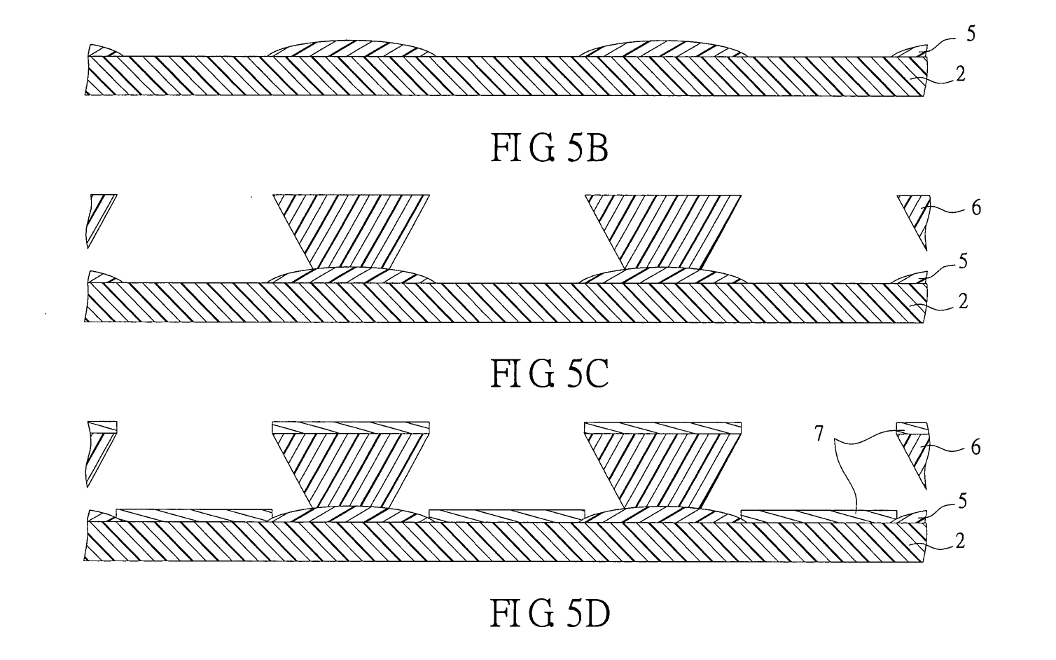

Please refer to FIG. 5A to FIG. 5D, manufacturing flow charts of the first embodiment in accordance with the present invention which comprise the steps of: (a) using chemicals, such as detergent and so on, and water to wash to make a transparency substrate 2; (b) using a photoresist material, such as polyimide, acrylic or other materials, and a lithographic process to grow an isolation area 5 on the transparency substrate 2 as isolation; (c) applying the photoresist material, such as polyimide, acrylic or other materials, on the obtained structure and then using the lithographic process to make a separation area 6 with a predetermined height such that the separation area 6 is existed on the isolation area 5; and (d) growing at least one metallic conductive layer 7 on the obtained structure. This way, the isolation area 5 isolates the electrical connection of adjacent leading wires, while the separation area 6 with the predetermined height separates apart and electrically isolates the at least one metallic conductive layer 7 provided on the separation area 6 and the metallic conductive layer 7 provided on the transparency substrate 2 and further avoids from electric interference of adjacent leading wires.

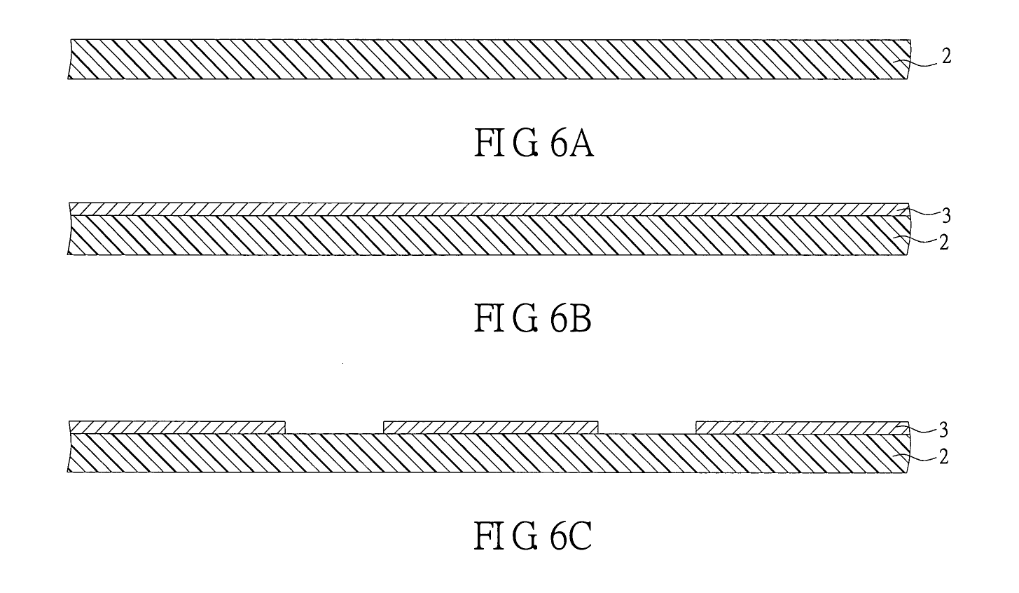

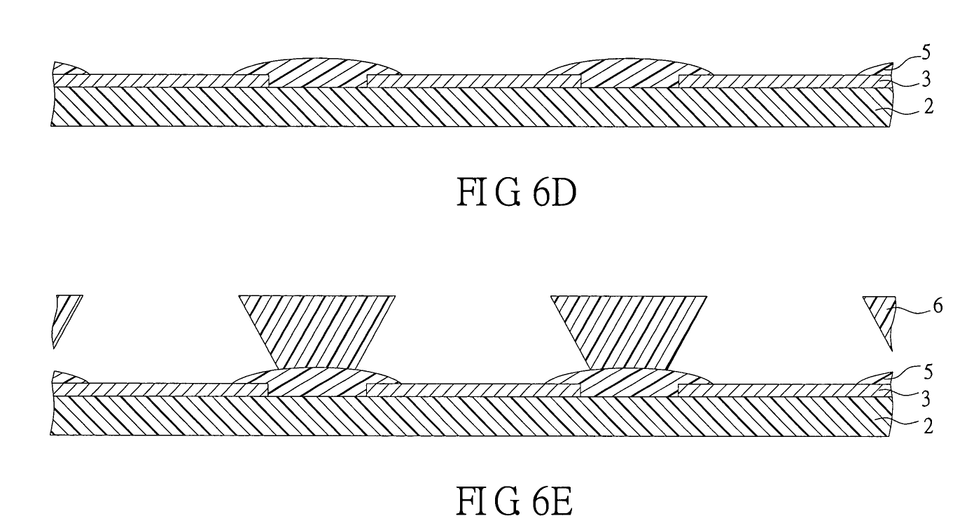

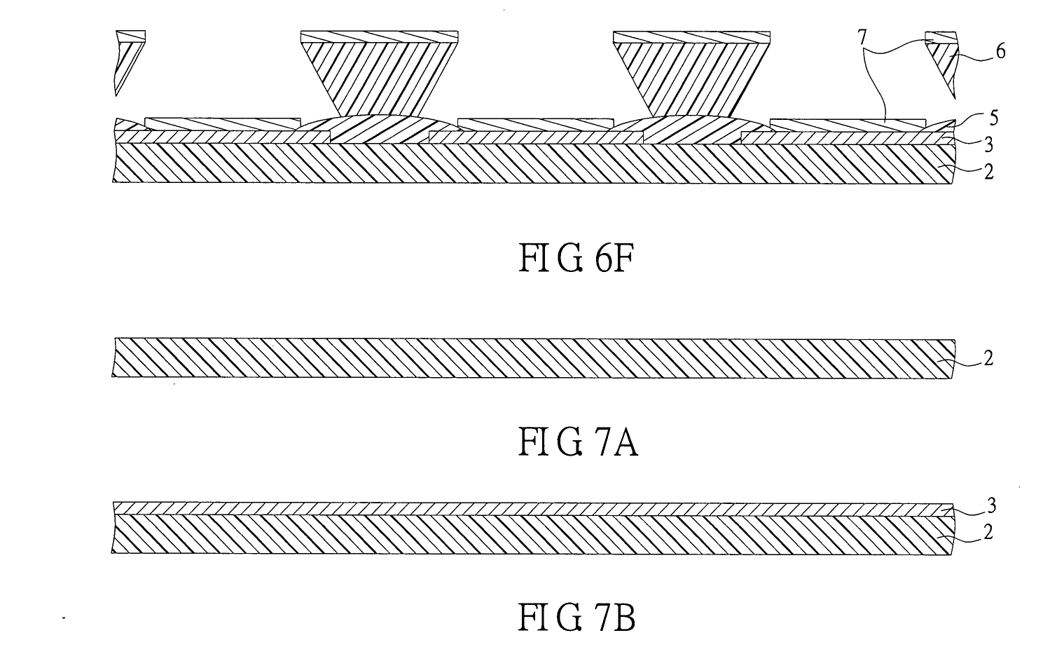

Please refer to FIG. 6A to FIG. 6F, manufacturing flow charts of the second embodiment in accordance with the present invention which comprise the steps of: (a) using chemicals, such as detergent and so on, and water to wash to make a transparency substrate 2; (b) growing a transparency conductive thin film (for example: ITO, IZO or IWO etc.) on the transparency substrate 2 and using a lithographic etching process to make a leading wire pattern layer 3; (c) using a photoresist material, such as polyimide, acrylic or other materials, and a lithographic process to grow an isolation area 5 on the leading wire pattern layer 3 as isolation; (d) applying the photoresist material, such as polyimide, acrylic or other materials, on the obtained structure and then using the lithographic process to make a separation area 6 with a predetermined height such that the separation area 6 is existed on the isolation area 5; and (e) growing at least one metallic conductive layer 7 on the obtained structure. This way, the isolation area 5 isolates the electrical connection of adjacent leading wires, while the separation area 6 with the predetermined height separates apart and electrically isolates the metallic conductive layers 7 respectively provided on the separation area 6 and metallic layer 7 on the leading wire pattern layer 3 and further avoids from electric interference of adjacent leading wires. Besides, the at least one metallic conductive layer 7 on the separation area 6, the metallic conductive layer 7 on the leading wire pattern layer 3, and the leading wire pattern layer 3 are in a parallel connection to reduce the electrode impedance.

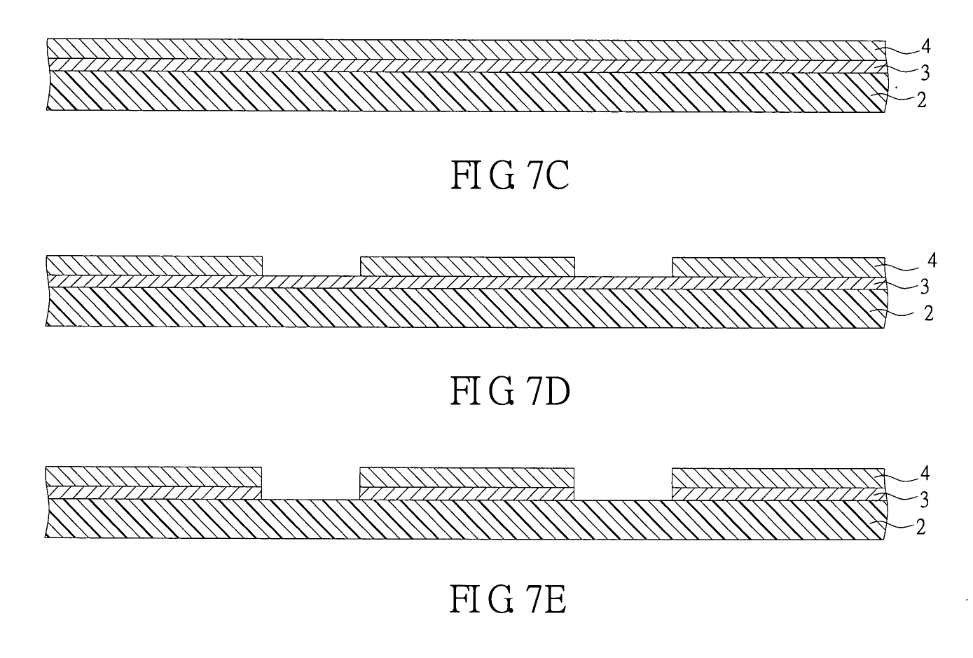

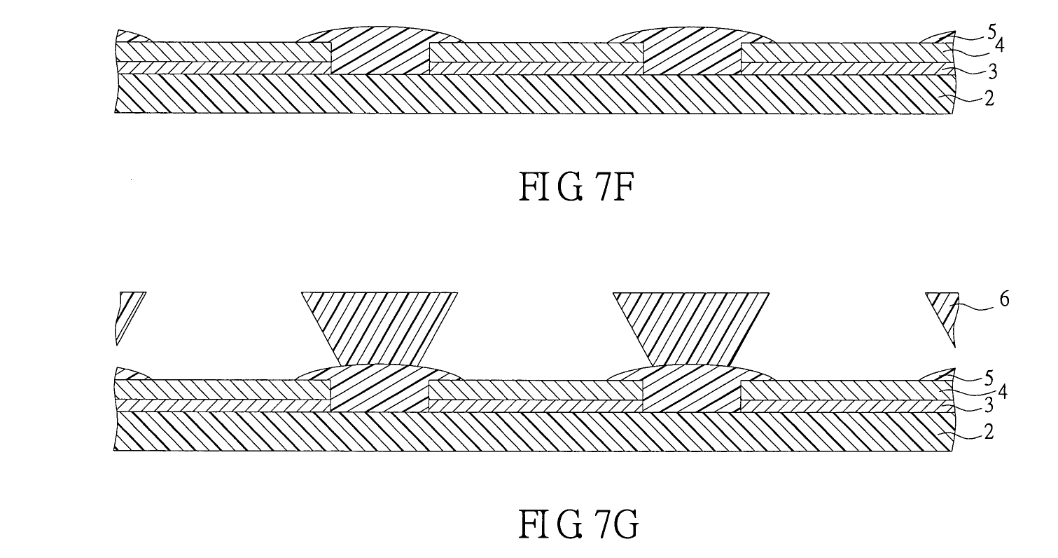

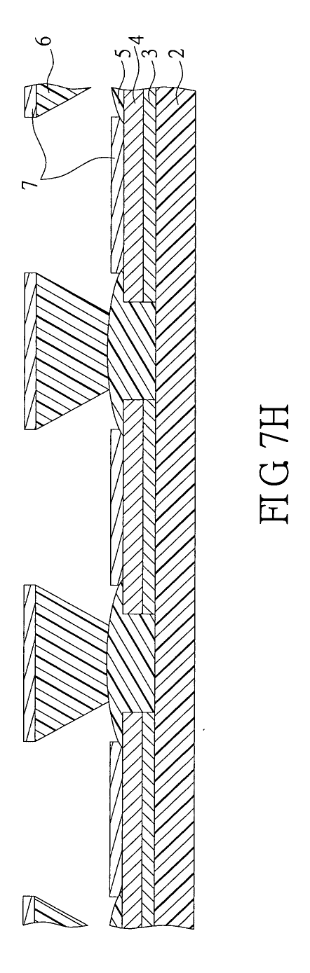

Please refer to FIG. 7A to FIG. 7H, manufacturing flow charts of the second embodiment in accordance with the present invention which comprise the steps of: (a) using chemicals, such as detergent and so on, and water to wash to make a transparency substrate 2; (b) growing a transparency conductive thin film (ex: ITO, IZO or IWO etc.) on the transparency substrate 2; (c) growing at least one auxiliary metallic conductive thin film on the transparency conductive thin film by a sputter machine or an e-beam machine; (d) using a lithographic etching process to make a leading wire pattern layer 3 and an auxiliary metallic pattern layer 4; (f) using a photoresist material, such as polyimide or acrylic material, and a lithographic process to grow an isolation area 5 on the auxiliary metallic pattern layer as isolation; (g) applying the photoresist material, such as polyimide, acrylic or other materials, on the obtained structure and then using the lithographic process to make a separation area 6 with a predetermined height such that the separation area 6 is existed on the isolation area 5; and (h) growing at least one metallic conductive layer 7 on the obtained structure. This way, the isolation area 5 isolates the electrical connection of adjacent leading wires, while the separation area 6 with the predetermined height separates apart and electrically isolates the at least one metallic conductive layer 7 provided on the separation area 6 and the metallic conductive layer 7 provided on the auxiliary metallic pattern layer and further avoids from electric interference of adjacent leading wires. Besides, the at least one metallic conductive layer 7 on the separation area 6, the metallic conductive layer 7 on the leading wire pattern layer 3, the leading wire pattern layer 3, and the auxiliary metallic pattern layer 4 are in a series connection to reduce the electrode impedance.

The electrode structure of the organic electroluminescent display panel and the method of manufacturing the same of the present invention have following advantages:

1. Using the electrode isolation layer to make external leading wire area without increasing material cost or increasing process to effectively reduce the impedance of the external leading wires. By the separation area, the metallic conductive layer on the transparency substrate, and the leading wire pattern layer (for example: ITO, IZO or IWO etc.) or at least one layer of the auxiliary metallic pattern layer in a series connection, the impedance of the electrode is effectively reduced to improve the light emitting efficiency.

2. By directly using the electrode separator layer (including the isolation structure such as insulator and so on) to make external leading wires (including both cathode and anode electrodes), the isolation area or the separation area in the present invention is not limited in defining pixel light emitting area, as well as is the isolation structure of the external leading wires to improve manufacture efficiency.

In summary, the present invention can truly achieve anticipated objects and effects. However, the above disclosed technical means is only a preferred embodiment of the present invention, and all equivalent variations and modifications in process, method, feature, and spirit in accordance with the appended claims may be made without in any way from the scope of the invention.

### LIST OF REFERENCE SYMBOLS

10 electrode structure of an organic electroluminescent display panel
11 cathode structure
12 anode structure
2 transparency substrate
3 leading wire pattern layer
4 auxiliary metallic pattern layer
5 isolation area
6 separation area
7 metallic conductive layer

1. An electrode structure of an organic electroluminescent display panel, comprising:
a transparency substrate;
a leading wire pattern layer provided on said transparency substrate;
an isolation area provided on said leading wire pattern layer for isolation;
a separation area provided on said isolation area with an raised predetermined height to separate electric interference; and
at least one metallic conductive layer provided on said leading wire pattern layer and said separation area.

2. The electrode structure of an organic electroluminescent display panel according to claim 1, wherein said metallic conductive layer on said separation area and said metallic conductive layer on said transparency substrate are in a series connection.

3. The electrode structure of an organic electroluminescent display panel according to claim 1, wherein said metallic conductive layer on said separation area, said metallic conductive layer on said leading wire pattern layer, and said leading wire pattern layer are in a series connection.

4. The electrode structure of an organic electroluminescent display panel according to claim 1, wherein said leading wire pattern layer can be made from one of materials of a transparency conductive material Indium Tin Oxide(ITO), Indium Zine Oxide(IZO) and Indium Tungsten Oxide(IWO).

5. The electrode structure of an organic electroluminescent display panel according to claim 1, wherein said isolation area can be made from one of materials of a polyimide, acrylic and other materials.

6. The electrode structure of an organic electroluminescent display panel according to claim 1, wherein said separation area can be made from one of materials of a polyimide, acrylic and other materials.

7. The electrode structure of an organic electroluminescent display panel according to claim 3, further comprising at least one auxiliary metallic pattern layer provided between said leading wire pattern layer, and said isolation area, wherein said metallic conductive layer provided between said auxiliary metallic pattern layer and said separation area.

8. The electrode structure of an organic electroluminescent display panel according to claim 7, wherein said metallic conductive layer on said separation area, said metallic conductive layer on said leading wire pattern layer, said leading wire pattern layer and said auxiliary metallic pattern layer are in a series connection.

9. A method of manufacturing an electrode structure of an organic electroluminescent display panel comprising:
making a transparency substrate;
growing a transparency conductive thin film on said transparency substrate and using a lithographic etching process to make a leading wire pattern layer; using a photoresist material and a lithographic process to grow an isolation area on said transparency substrate for isolation;
applying said photoresist material on said obtained structure and making a separation area with a predetermined height by proceeding said lithographic process, wherein said separation area is existed on said isolation area; and
growing at least one metallic conductive layer on the obtained structure.

10. The method of manufacturing an electrode structure of an organic electroluminescent display panel according to claim 9, wherein using chemicals, such as Detergent and so on, and water to wash said substrate transparency before making said transparency substrate.

11. The method of manufacturing an electrode structure of an organic electroluminescent display panel according to claim 9, wherein said transparency conductive thin film is grown by a sputter machine.

12. The method of manufacturing an electrode structure of an organic electroluminescent display panel according to claim 9, further comprising growing at least one auxiliary metallic conductive thin films on said transparency pattern layer.

13. The method of manufacturing an electrode structure of an organic electroluminescent display panel according to claim 12, wherein auxiliary metallic conductive thin films are grown by said sputter machine.

14. The method of manufacturing an electrode structure of an organic electroluminescent display panel according to claim 12, wherein auxiliary metallic conductive thin films are grown by an e-beam machine.
